(19) United States
(12) Patent Application Publication
(10) Pub. No.: US 2020/0246882 A1
(43) Pub. Date: Aug. 6, 2020

(54) DEVICE FOR DETACHING AT LEAST ONE BURR FROM AN OPENING OF AT LEAST ONE TRANSVERSE BORE-HOLE OF A WORKPIECE, DRILLING STATION HAVING THE DEVICE AND METHOD FOR DETACHING THE AT LEAST ONE BURR USING THE DRILLING STATION

(71) Applicant: Schaeffler Technologies AG & Co. KG, Herzogenaurach (DE)

(72) Inventor: Andreas Martin, Hirschaid (DE)

(73) Assignee: Schaeffler Technologies AG & Co. KG, Herzogenaurach (DE)

(21) Appl. No.: 16/641,860

(22) PCT Filed: Jul. 26, 2018
(86) PCT No.: PCT/DE2018/100668

§ 371 Date: Feb. 25, 2020

(30) Foreign Application Priority Data
Aug. 31, 2017 (DE) 10 2017 119 966.7

(51) Int. Cl. B23B 51/10; B23B 35/00

(52) U.S. Cl. CPC B23B 51/105; B23B 2215/20; B23B 2215/16; B23B 35/00

(57) ABSTRACT

A device for detaching a burr from an opening of a transverse borehole of a workpiece includes an elongate shank for positioning in a longitudinal borehole of the workpiece and a fillet to avoid the elongate shank colliding with a drill for drilling the transverse borehole. In an example embodiment, the device has an aperture to further avoid the elongate shank colliding with the drill. In an example embodiment, the elongate shank has a cutting section with a cutting edge for detaching the burr from the opening of the transverse borehole.

### CROSS-REFERENCE TO RELATED APPLICATIONS

This application is the United States National Phase of PCT Appln. No. PCT/DE2018/100668 filed Jul. 26, 2018, which claims priority to German Application No. DE102017119966.7 filed Aug. 31, 2017, the entire disclosures of which are incorporated by reference herein.

### TECHNICAL FIELD

The disclosure relates to a device for detaching at least one burr from an opening of at least one transverse borehole of a workpiece. The device has an elongate shank, which can be introduced into a longitudinal borehole of the workpiece and can be positioned therein. The disclosure furthermore relates to a drilling station having the device, the workpiece and at least one drill for drilling the at least one transverse borehole, and to a method for detaching the at least one burr from the opening of the at least one transverse borehole by means of the drilling station.

### BACKGROUND

During the introduction of boreholes into workpieces, burrs are often formed, these being arranged at one end of the boreholes. To enhance the quality of the workpieces, the burrs must be removed. This is often performed by a deburring tool in a separate work step after the introduction of the boreholes.

DE 103 21 670 A1, for example, describes a tool, a device and a method for deburring holes that open laterally into a cylindrical aperture. The tool has a shank with a cutting section for deburring the holes. For this purpose, the tool can be introduced into the aperture and rotated in the latter.

### SUMMARY

A device is proposed which is designed to detach at least one burr from an opening of at least one transverse borehole of a workpiece. The at least one transverse borehole preferably opens into a longitudinal borehole of the workpiece. In particular, the at least one burr and/or swarf is formed as the at least one transverse borehole is drilled in the region of the opening into the longitudinal borehole. The at least one burr and/or swarf can be detached by the device and optionally, in addition, can be removed, in particular carried away, from the longitudinal borehole. The workpiece is a vehicle component, for example, in particular a selector valve housing, a camshaft or a crankshaft.

The device has an elongate shank. The shank can be introduced into the longitudinal borehole of the workpiece and can be positioned therein. The shank preferably comprises a cutting section. In particular, the cutting section is arranged on the end of the shank. However, it is particularly advantageous if the cutting section extends along the shank from a free end of the shank. In particular, the cutting section extends over at least 30 percent, preferably at least 50 percent, in particular at least 70 percent and/or at most 95 percent of an overall length of the shank from the free end.

The cutting section optionally has at least one cutting edge for detaching the at least one burr from the opening. As a particular preference, the device comprises two cutting edges, which, in particular, are arranged on two opposite sides of the cutting section. By means of the two cutting edges, the workpiece can be deburred in two opposite rotational directions as the workpiece is rotated about the shank at the opening of the at least one transverse borehole.

The device optionally comprises a grip, which is arranged on the shank on an opposite side from the cutting section. A worker can preferably handle the device by means of the grip, in particular can introduce the shank into the longitudinal bore, position it therein and remove the shank again from the longitudinal bore.

According to the disclosure, the device has at least one fillet. The fillet is arranged and/or designed to avoid the shank colliding with at least one drill by means of which the at least one transverse borehole can be introduced and/or is/can be drilled. In particular, the fillet on the shank prevents collision with the at least one drill since the shank is arranged in the longitudinal borehole while the transverse borehole is being introduced and/or drilled. The fillet preferably extends along a longitudinal extent of the shank, in particular through the cutting section. For example, the fillet has a length which is at least 30 percent, preferably at least 40 percent and, in particular, at least 50 percent, of the longitudinal extent of the shank. The fillet sets the cutting edges far apart, for example, and, as a result, they extend at a distance from one another, in particular along their longitudinal extent. More specifically, the fillet extends between the two cutting edges along the cutting section.

In a preferred embodiment of the disclosure, the device has at least one aperture. In particular, the at least one aperture is designed to prevent collision between the shank and the at least one drill by means of which the at least one transverse borehole is drilled. More specifically, the at least one aperture serves as an additional collision safeguard to the fillet.

The at least one aperture is designed as at least one blind hole or as at least one through hole in the shank, for example. The at least one aperture is preferably arranged so as to overlap with the fillet and/or in the fillet, in particular in the region of the cutting section. As a particular preference, the device has two apertures, which are arranged spaced apart on the shank and/or on the cutting section. The apertures prevent collision with a drill tip of the at least one drill by means of which the at least one transverse borehole can be introduced or is introduced into the workpiece. It is possible, within the scope of the disclosure, for the apertures to have different diameters. This enables transverse boreholes of different diameters to be drilled into the workpiece without colliding with the shank.

In a preferred design embodiment of the disclosure, the device comprises a cooling arrangement. The cooling arrangement preferably has a cooling channel for passing a coolant through the shank of the device. The cooling arrangement is preferably designed to cool the device, especially in the case of and/or during deburring. Cooling is necessary especially because the workpiece rotates about the shank of the device immediately after the drilling of the at least one transverse borehole. In the case of and/or during rotation, the cutting section detaches the at least one burr, which is arranged and/or formed at the opening of the transverse borehole into the longitudinal borehole, by means of the at least one cutting edge. Cooling is intended to prevent running hot and/or overheating in the case of and/or during rotation of the workpiece and/or in the case of or during deburring. As a preferred option, additional loose burrs can be removed from the workpiece by means of the cooling, especially at high pressure.

Another particularly preferred embodiment of the disclosure envisages that the cooling channel, in particular the coolant passed through the channel, is designed to carry away the at least one detached burr out of the longitudinal borehole of the workpiece. For this purpose, the cooling channel preferably opens into the free end of the shank, particularly in the region of the cutting section. This enables the coolant to emerge into the longitudinal bore of the workpiece at the free end of the shank and to carry away the at least one detached burr out of said bore.

The disclosure also relates to a drilling station having the at least one drill, the workpiece and the device in accordance with the above description and/or as claimed in any one of claims 1 to 4.

The drilling station is preferably designed as a worktable or a workbench. In particular, the drilling station is integrated into a production line for the production of vehicle components, e.g. of a selector valve housing, camshafts or crankshafts.

In a preferred implementation of the disclosure, the workpiece has the longitudinal borehole. The shank of the device is preferably arranged in the longitudinal borehole. In particular, the workpiece can be rotated about the shank from a first rotational position into a second rotational position. For this purpose, the workpiece is mounted on a rotation device of the drilling station, for example.

As a particularly preferred option, a first transverse borehole can be introduced into the workpiece by the drill in the first rotational position. It is furthermore preferred if a second transverse borehole can be introduced into the workpiece by the drill or by a further drill of the drilling station in the second rotational position. It is possible, in particular, for at least one further transverse borehole, e.g. two further transverse boreholes, to be introduced into the workpiece. In particular, the first transverse borehole, the second transverse borehole and optionally, in addition, the at least one further transverse borehole open into the longitudinal borehole.

In a preferred embodiment of the disclosure, the shank is positioned in the longitudinal borehole of the workpiece in such a way that drilling of the at least one transverse borehole, in particular of the transverse boreholes, without collisions with the shank is made possible by the fillet. For this purpose, it is particularly preferred if an opening of the fillet is directed to at least one point at which the at least one transverse borehole, in particular the transverse boreholes, is/are to be introduced or is/are to be capable of being introduced into the workpiece. Alternatively or as an optional addition, the fillet is arranged in such a way as to be congruent and/or overlapping with the at least one point in a plan view of said point.

A preferred embodiment of the disclosure envisages that the shank is positioned in the longitudinal borehole of the workpiece in such a way that collision-free drilling of the at least one transverse borehole, in particular of the transverse boreholes, is made possible by the at least one aperture. In particular, an opening of the first aperture is directed to the first transverse borehole, more specifically to a point at which the drill drills or is intended to drill the first transverse borehole, and is arranged in such a way as to be overlapping or congruent below this point. More specifically, an opening of the second aperture is directed to the second transverse borehole, more specifically to a further point at which the drill drills or is intended to drill the second transverse borehole, and is arranged in such a way as to be overlapping or congruent below this further point.

Through the appropriate positioning of the fillet and/or of the at least one aperture, sufficient space is created for a drill tip of the drill when the drill is drilling the at least one transverse borehole and penetrates into the longitudinal borehole with the drill tip. It is thereby possible to avoid a collision between the at least one drill and the shank.

The disclosure also relates to a method for detaching the at least one burr from the opening of the at least one transverse borehole of the workpiece by means of the drilling station in accordance with the above description and/or as claimed in any one of claims 5 to 7.

As part of the method, the shank of the device is preferably introduced into the longitudinal borehole. In particular, the at least one drill drills the at least one transverse borehole while the shank is arranged in the longitudinal borehole.

As a particular preference, as part of the method, the workpiece is rotated about the shank of the device from the first rotational position into the second rotational position. In particular, the at least one burr is detached from the opening of the at least one transverse borehole by the device, in particular by the at least one cutting edge of the cutting section, during the rotation of the workpiece. It is thereby advantageously possible to carry out the deburring of the drilled transverse borehole simultaneously with the rotation of the workpiece. The opening of the transverse borehole can preferably be deburred in a manner which is neutral in terms of the cycle time or virtually neutral in terms of the cycle time for the drilling of the at least one transverse borehole. In particular, it is possible to dispense with a separate working section for deburring the opening, a section which would adjoin a working section for drilling the at least one transverse borehole. It is thereby possible to save production time and costs in the production of the workpiece.

As an option, the shank of the device can be removed from the longitudinal bore and reintroduced into the latter after the rotation of the workpiece from the first into the second rotational position. In particular, the workpiece can then preferably be rotated, optionally with a small additional expenditure of time, in a direction of rotation opposite to the previous direction of rotation, thereby ensuring that any burrs which are still present can be detached from the opening of the at least one transverse borehole and removed from the longitudinal borehole.

As part of the method, it is preferred if the at least one burr detached is carried away out of the longitudinal bore of the workpiece by the cooling fluid. It is thereby possible to prevent burrs which have already been detached and have remained in the longitudinal borehole from hindering the cutting section. In particular, it is thereby possible to ensure deburring of the opening of the at least one transverse borehole in a reliable process.

### BRIEF DESCRIPTION OF THE DRAWINGS

Further features, advantages and effects of the disclosure will become apparent from the following description of preferred illustrative embodiments of the disclosure. In the drawings:

FIG. 1 shows a perspective view of a device for detaching at least one burr from an opening of at least one transverse borehole of a workpiece;

FIG. 2 shows the device from FIG. 1 in a plan view from above;

FIG. 3 shows a longitudinal section of the device from FIG. 2 along section line A-A;

FIG. 3a shows a section through the device from FIG. 3 along section line B-B;

FIG. 3b shows a section through the device from FIG. 3 along section line C-C;

FIG. 4 shows a workpiece having a longitudinal bore and having a first and a second transverse bore, wherein a shank of the device from FIG. 1 is arranged in the longitudinal bore;

FIG. 4a shows a section through the workpiece and the shank from FIG. 4 along section line B-B;

FIG. 4b shows a section through the workpiece and the shank from FIG. 4 along section line C-C; and

FIG. 5 shows a longitudinal section through the workpiece and the shank from FIG. 4, wherein two drills drill two transverse boreholes, which open into the longitudinal borehole.

In the figures, corresponding or identical parts are in each case provided with the same reference signs.

### DETAILED DESCRIPTION

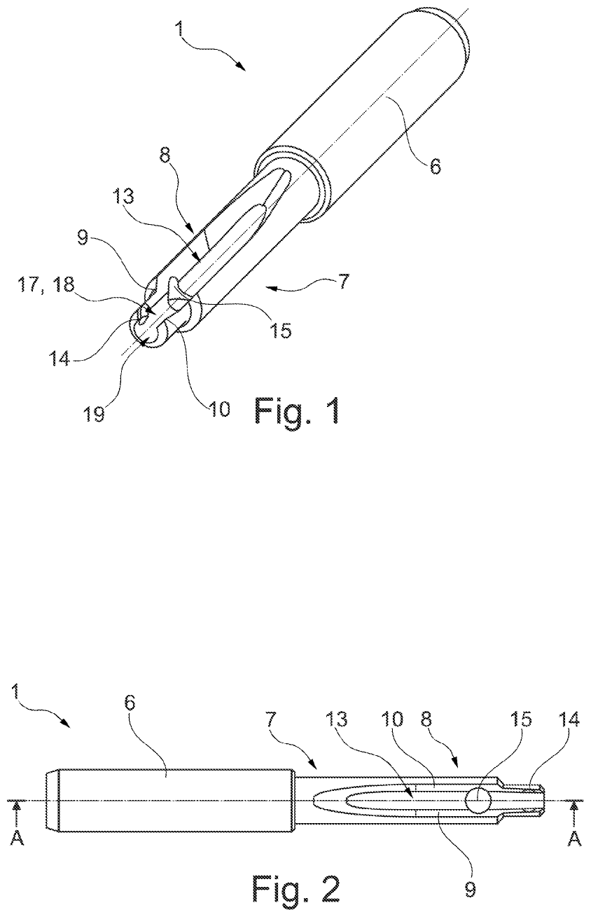

FIG. 1 shows a perspective view of a device 1 of a drilling station (not shown). The drilling station is a worktable, for example, which can be part of a production line for motor vehicle components.

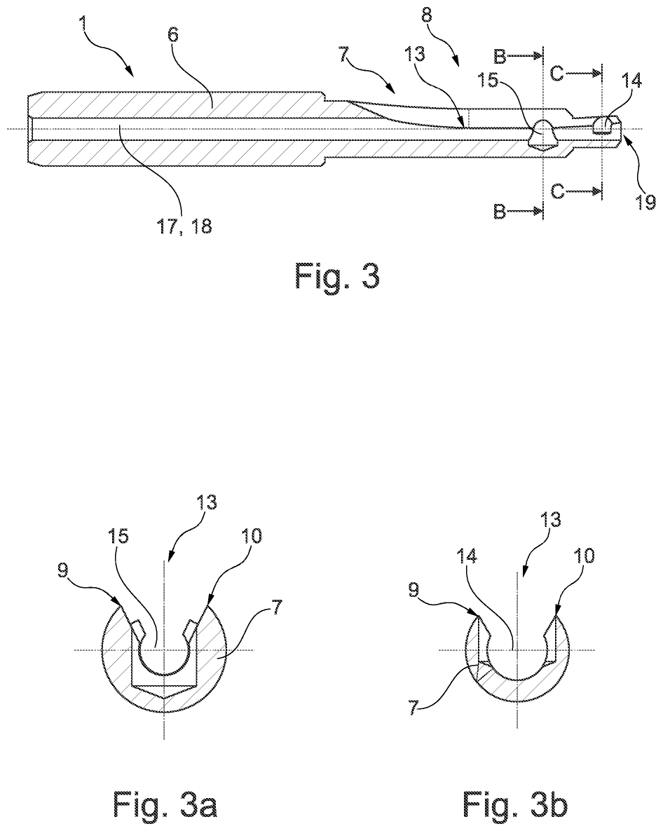

FIG. 2 shows a plan view from above of the device 1 from FIG. 1. FIG. 3 shows a longitudinal section through the device 1 from FIG. 2 along section line A-A. FIGS. 3a and 3b show cross sections through the device 1 along section lines B-B and C-C.

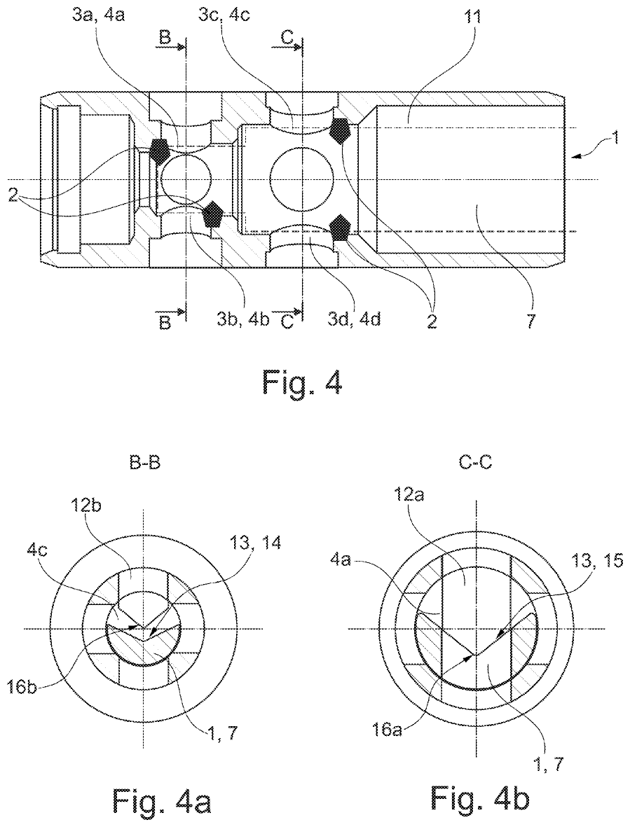

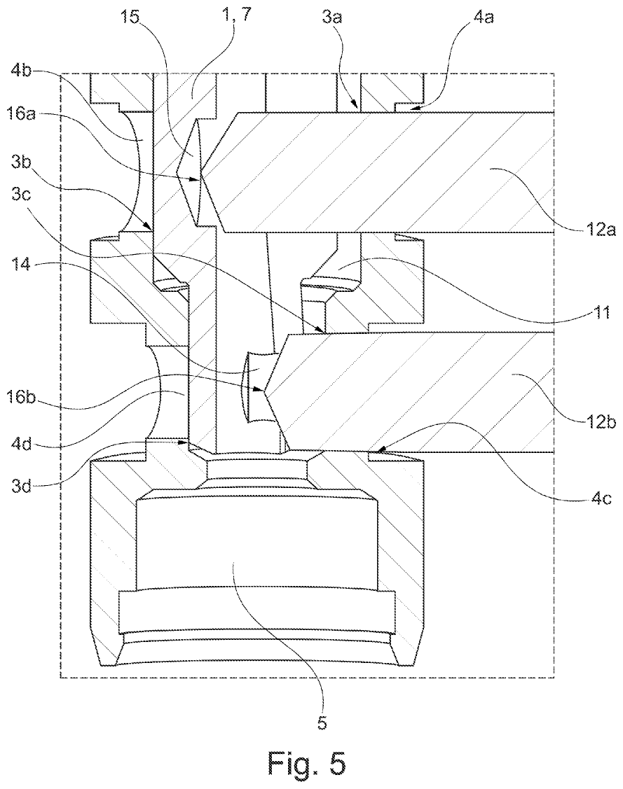

The device 1 is designed to detach at least one burr 2 (FIG. 4) from an opening 3 (FIG. 4) of at least one transverse borehole 4 (FIG. 4) of a workpiece 5 of the drilling station. The workpiece 5 is shown in FIGS. 4 and 5. It is designed as a vehicle component, for example, in particular as a camshaft, as a selector valve housing or as a crankshaft. It has a longitudinal borehole 11 (FIGS. 4 and 5), into which the at least one transverse borehole 4, in particular a first, second, third and fourth transverse borehole 4a, 4b, 4c, 4d, opens. Thus, the workpiece 5 has four openings 3a, 3b, 3c, 3d.

The first and third transverse boreholes 4a, 4b can be introduced and/or have been introduced into the workpieces by means of the first drill 12a (FIG. 5) of the drilling station, and the second and fourth transverse boreholes 4c, 4d can be introduced and/or have been introduced into the workpiece 5 by means of a second drill 12b (FIG. 5) of the drilling station.

The workpiece 5 is mounted rotatably on the drilling station, thus enabling the workpiece 5 to be rotated from a first rotational position R into a second rotational position (not shown). In the first rotational position R, shown in FIG. 5, the first transverse borehole 4a is drilled and, in the second rotational position, the second transverse borehole 4b is drilled. In the case of a further rotation process, the third transverse borehole 4c is drilled in the first rotational position R, and the fourth transverse borehole 4d is drilled in the second rotational position.

According to FIGS. 1, 2 and 3, the device 1 is designed as an elongate component with a grip 6 for handling the device 1 and with a shank 7 for introduction into and positioning in the longitudinal borehole 11 of the workpiece 5. The shank 7 adjoins the grip 6 and is secured thereon. As an option, the shank is clamped in the grip 6 and is preferably positioned correctly on the grip 6 by means of a positioning surface.

The shank 7 is of stepped design and has at least two different diameters along its overall length. This makes it possible to deburr workpieces 5 which have a longitudinal borehole 11 with step changes in diameter. As an alternative, the shank 7 can have an invariable diameter along its overall length, thus making it possible to deburr workpieces 5, the longitudinal boreholes 11 of which have a constant diameter. The device 1, in particular the shank 7, is formed from a hard metal or from a tool steel, preferably a high-alloy tool steel.

The shank 7 comprises a cutting section 8 for detaching the at least one burr 2 from the opening 3 of the at least one transverse borehole 4 of the workpiece 5. The cutting section 8 has a first cutting edge 9 and a second cutting edge 10. Cutting section 8 extends over at least 30 percent, preferably at least 50 percent, in particular at least 70 percent and/or at most 95 percent of an overall length of the shank 7.

The shank 7 is introduced into the longitudinal borehole 11 of the workpiece 5 and positioned therein, as shown in FIGS. 4 and 5. The drilling of the transverse boreholes 4a, 4b, 4c, 4d takes place while the shank 7 is arranged in the longitudinal borehole 11.

To avoid a collision between the shank 7 and the first and second drills 12a, 12b in the case of and/or during drilling, the device 1 has a fillet 13, which is introduced into the shank 7. In particular, the shank 7 has the fillet 13. This extends over at least 30 percent, preferably at least 40 percent and in particular at least 50 percent of an overall length of the shank 7. The fillet 13 furthermore extends completely or almost completely along the cutting section 8, with the result that the two cutting edges 9, 10 delimit the fillet 13 at the sides.

To ensure the avoidance of a collision between the shank 7 and the first and second drills 12a, 12b, in particular drill tips 16a, 16b of the two drills 12a, 12b, the device 1 has a first and a second aperture 14, 15. As shown in FIGS. 3, 3a and 3b, the apertures 14, 15 are introduced as blind holes into the shank 7 and arranged in the fillet 13. As an alternative, it is also possible for the apertures 14, 15 to be designed as through holes.

The first aperture 14 has a smaller diameter than the second aperture 15. This enables the openings 3a, 3b, 3c, 3d of transverse bores 4a, 4b, 4c, 4d of different diameters to be deburred. Alternatively, it is possible for the two apertures to have corresponding diameters, in particular to enable openings of transverse boreholes with the same diameter to be deburred.

According to FIGS. 4 and 5, the shank 7 of the device 1 is arranged in the longitudinal bore 11 of the workpiece 5. The workpiece 5 occupies the first rotational position R. As can be seen especially from FIG. 5, the shank 7 of the device 1 is positioned in the longitudinal borehole 11 of the workpiece 5 in such a way that an opening of the fillet 13 is directed to the points at which the transverse boreholes 4a, 4c or 4b, 4d are drilled by the first and second drills 12a, 12b. In particular, the fillet 13 is arranged so as to overlap with the points.

In a plan view of the point at which the third transverse bore 4c is formed by the second drill 12b, the first aperture 14 is arranged below and congruently with the point. A collision with the drill tip 16b of the second drill 12b in the case of and/or during the drilling of the third transverse bore 4c is thereby avoided. In a plan view of the point at which the first transverse borehole 4a is formed by the first drill 12a, the second aperture 15 is arranged below and congruently with the point. A collision with the drill tip 16a of the first drill 12a in the case of and/or during the drilling of the first transverse borehole 4a is thereby avoided.

After the drilling of the first and third transverse boreholes 4a, 4c, the drills 12a, 12b are moved out of the respective transverse boreholes 4a, 4c. The workpiece 5 is rotated from the first rotational position R into the second rotational position. The rotation is carried out while the shank 7 of the device 1 is arranged in the longitudinal borehole 11. In the second rotational position, the drilling of the second and fourth transverse boreholes 4b, 4d can be carried out by the first and second drills 12a, 12b.

After the rotation of the workpiece 5 into the second rotational position, the shank 7 is positioned in the longitudinal borehole 11 of the workpiece 5 in such a way that the fillet 13 and the apertures 14, 15 are positioned in a corresponding manner to avoid collision with the drills 12a, 12b or with the drill tips 16a, 16b, as described above for the first rotational position R.

By means of the first cutting edge 9, the workpiece 5 can be deburred in the region of the openings 3a, 3c in the case of and/or during the rotation of the workpiece 5 from the first rotational position R into the second rotational position. For this purpose, in the case of and/or during the rotation of the workpiece 5, the first cutting edge 9 detaches the at least one burr 2, which is or can be arranged and/or formed on the opening 3a, 3c of the corresponding transverse borehole 4a, 4c by the drilling of the first and third transverse boreholes 4a, 4c.

By means of the second cutting edge 10, the workpiece 5 can be deburred in the region of the openings 3b, 3d in the case of and/or during the rotation into the second rotational position. For this purpose, in the case of and/or during the rotation of the workpiece 5 in the opposite direction, the second cutting edge 10 detaches the at least one burr 2, which is or can be arranged and/or formed on the opening 3b, 3d of the corresponding transverse borehole 4b, 4d by the drilling of the second and fourth transverse boreholes 4b, 4d.

According to FIG. 3, the device has a cooling arrangement 17 for cooling the shank 7 in the case of and/or during the rotation and deburring of the workpiece 5. The cooling arrangement 17 comprises a cooling channel 18, which extends completely through the grip and the shank 7 and opens into a free end 19 of the shank 7. Cooling fluid can be passed through the cooling channel 18 and emerges at the free end 19 of the shank 7. The cooling fluid picks up the at least one burr 2 detached from the respective opening 3 by the cutting section 8 and carries it away through the longitudinal borehole 11 of the workpiece. It is thereby possible to ensure deburring in a reliable process.

In summary, the corresponding openings 3a, 3b, 3c, 3d of the respective transverse boreholes 4a, 4b, 4c, 4d can be deburred simultaneously with the rotation of the workpiece 5 between the two rotational positions. This has the advantage that deburring can take place in a manner which is neutral in terms of the cycle time or virtually neutral in terms of the cycle time for the drilling of the transverse boreholes 4a, 4b, 4c, 4d. It is furthermore advantageous that a separate work step for deburring the workpiece 5 can be eliminated and, as a result, that production time and costs can be saved. In particular, unwanted folding over of the at least one burr as a deburring tool is introduced into the longitudinal borehole after the at least one transverse borehole has been drilled, something which often occurs in the case of the separate work step, can therefore be avoided.

### REFERENCE NUMERALS

1 device
2 burr
3 opening
4 transverse borehole
5 workpiece
6 grip
7 shank
8 cutting section
9 first cutting edge
10 second cutting edge
11 longitudinal borehole
12 drill
13 fillet
14 first aperture
15 second aperture
16 drill tip
17 cooling arrangement
18 cooling channel
19 free end
R rotational position

1.-10. (canceled)

11. A device for detaching a burr from an opening of a transverse borehole of a workpiece, comprising:
an elongate shank for positioning in a longitudinal borehole of the workpiece; and
a fillet to avoid the elongate shank colliding with a drill for drilling the transverse borehole.

12. The device of claim 11, further comprising an aperture to further avoid the elongate shank colliding with the drill.

13. The device of claim 11, wherein the elongate shank comprises a cutting section having a cutting edge for detaching the burr from the opening of the transverse borehole.

14. The device of claim 11, comprising a cooling arrangement for cooling the elongate shank, the cooling arrangement comprising a cooling channel for passing a coolant through the elongate shank and for introducing the coolant into the longitudinal borehole of the workpiece, thus enabling the burr to be carried away out of the longitudinal borehole by the coolant.

15. A drilling station comprising:
a drill;
a workpiece; and
the device of claim 11.

16. A drilling station comprising:
a drill;
a workpiece; and
the device of claim 12.

17. The drilling station of claim 16, wherein:
the workpiece comprises the longitudinal borehole;
the elongate shank of the device is arranged in the longitudinal borehole;
the workpiece is rotatable about the elongate shank from a first rotational position (R) into a second rotational position;
a first transverse borehole can be introduced into the workpiece by the drill in the first rotational position (R);
a second transverse borehole can be introduced into the workpiece by the drill in the second rotational position; and
the elongate shank is positioned in the longitudinal borehole such that the fillet or the aperture permits collision-free drilling of the first transverse borehole or the second transverse borehole by the drill.

18. The drilling station of claim 17, wherein:
the fillet or the aperture comprises an entrance directed to a point at which the first transverse borehole or the second transverse borehole is to be introduced; or
the fillet or the aperture is arranged to be congruent or overlapping with the point in a plan view of the point.

19. A method comprising detaching a burr from an opening of a transverse borehole of a workpiece using the drilling station of claim 15.

20. The method of claim 19, wherein:
wherein the elongate shank of the device is introduced into the longitudinal borehole of the workpiece; and
the drill drills the transverse borehole while the elongate shank is arranged in the longitudinal borehole.

21. The method of claim 19, wherein:
the workpiece is rotated about the elongate shank of the device from a first rotational position (R) into a second rotational position; and
the burr is detached from the opening by the device during or simultaneously when the workpiece is rotated.

22. A method for removing a burr comprising:
providing a tool with an elongate shank, the elongate shank comprising a cutting section comprising a first cutting edge and a second cutting edge;
providing a workpiece with a longitudinal borehole;
inserting the tool into the longitudinal borehole;
drilling a first transverse borehole in the workpiece using a first drill; and
rotating the workpiece or the tool to remove a burr created during the drilling.

23. The method of claim 22 wherein:
the tool comprises a fillet extending longitudinally along the elongate shank through the cutting section; and
the drill comprises a tip extending towards the fillet during the drilling.

24. The method of claim 23 wherein
the tool comprises an aperture; and
the tip extends into the aperture during the drilling.

25. The method of claim 22 wherein the tool further comprises a grip and the step of inserting the tool into the longitudinal borehole is performed by a human holding the grip.

26. The method of claim 22, further comprising drilling a second transverse borehole in the workpiece using a second drill prior to the step of rotating the workpiece or the tool.

27. The method of claim 22, further comprising drilling a second transverse borehole in the workpiece using the first drill after the step of rotating the workpiece or the tool.
